(19) United States
(12) Patent Application Publication
(10) Pub. No.: US 2013/0190073 A1
(43) Pub. Date: Jul. 25, 2013

(54) NETWORKLESS TICKETING SOLUTION

(71) Applicants: John Edmunds, Twyford (GB); Robert Denham, Cheltenham (GB); Fivos Polymniou, Stockport (GB)

(72) Inventors: John Edmunds, Twyford (GB); Robert Denham, Cheltenham (GB); Fivos Polymniou, Stockport (GB)

(73) Assignee: FUTURELOGIC, INC., Glendale, CA (US)

(21) Appl. No.: 13/357,519

(22) Filed: Jan. 24, 2012

Related U.S. Application Data
(63) Continuation of application No. PCT/US12/22140, filed on Jan. 23, 2012.

(51) Int. Cl. A63F 13/12

(52) U.S. Cl. 463/25

(57) ABSTRACT

Methods and apparatus for networkless vouchering or ticketing. A Networkless Ticketing Solution (NTS) includes an NTS system control card connected to a gaming machine controller of a gaming machine. The NTS system control card receives cashout information from the gaming machine controller and instructs an NTS printer to print encrypted cashout vouchers or tickets. A redemption device scans the encrypted vouchers or tickets and provides a display to a cashier for cashing out the vouchers or tickets.

### CROSS-REFERENCE TO RELATED APPLICATION

The present application is a continuation of, and claims the priority of, PCT Application No. PCT/US2012/22140, filed Jan. 23, 2012, the content of which is hereby incorporated by reference as if fully stated herein.

### BACKGROUND OF THE INVENTION

1. Field of the Invention

The present disclosure relates generally to gaming and more specifically to gaming systems and peripherals used in gaming systems.

2. Background

The gaming machine manufacturing industry provides a variety of gaming machines for the amusement of gambling players. An exemplary gaming machine is a slot machine. A slot machine is an electronic or electro-mechanical gaming machine wherein chance or the skill of a player determines the outcome of a game played on the gaming machine. Slot machines are usually found in casinos or other more informal gaming establishments.

Gaming machine manufacturers have provided cashless enabled gaming machines to the market and there now exists a broad population of cashless enabled gaming machines in the gaming industry. Cashless enabled gaming machines are so named because these gaming machines conduct a player's financial exchange with the gaming machine using vouchers or tickets redeemable for cash or game credits, either exclusively or in conjunction with various types of currency or credits.

Two pieces of equipment typically used for a cashless enabled game are a printer to produce vouchers or tickets and a bill acceptor that supports automatic reading of vouchers or tickets. When a player using a cashless enabled gaming machine wishes to withdraw their credits, or “cashout”, the gaming machine is signaled and, depending on the size of the pay out, the gaming machine either presents the player with currency, such as coins in the traditional method of a slot machine, or the gaming machine causes a printer associated with the cashless enabled gaming machine to produce a voucher indicating the value of the pay out. The voucher may be redeemed for cash by a cashier or the like, or may be inserted into another cashless enabled gaming machine to be redeemed for credits, or “cashin” on the other cashless enabled gaming machine.

Cashless enabled gaming machines have found an increasing acceptance and use in the gaming industry with both the players, who enjoy the speed of play and ease of transporting their winnings around the casino, and with the casinos who have realized significant labor savings in the form of reduced coin hopper or cash dispenser reloads in the gaming machines, and an increase in revenue because of the increased speed of play. The broad installation base of cashless enabled games guarantees a wide installed base of gaming machines and their associated printers.

### SUMMARY

Typically, a cashless enabled gaming machine is coupled to a host system through a communications network for the purposes of accounting for each voucher that is printed or redeemed. However, a need exists for cashless enabled games in establishments that may have a limited number of gaming machines which does not justify installation of a host system or do not want the complexity and attendant cost of managing a host system. Various aspects of the present disclosure meet such a need.

During an initialization of a Networkless Ticketing Solution (NTS) system, a NTS system control card generates an encryption key. The encryption key is then transmitted by the NTS system control card to an NTS printer. The NTS printer, in turn, generates its own encryption key. Then, the NTS printer prints, as computer-readable indicia, both encryption keys onto a ticket. A redemption device scans the computer-readable indicia to determine the encryption keys. During an operational phase, the control card receives from a gaming machine controller, a cashout amount for a player playing the gaming machine. The NTS system control card then encrypts the cashout amount and transmits the encrypted cashout amount to the NTS printer. The NTS printer then encrypts the encrypted cashout amount again using the NTS printer's own encryption key and prints the doubly encrypted cashout amount as computer-readable indicia onto a cashout ticket. The redemption device scans the doubly encrypted computer-readable indicia from the cashout ticket and decrypts the doubly encrypted computer-readable indicia from the cashout ticket using the two encryption keys the redemption device had previously determined. The cashout amount is then displayed to a cashier for paying out the cashout ticket.

In another aspect, a NTS system control card will not only act as a simulated coin hopper or cash dispenser, the NTS system control card will also act as a host to one or more coin hoppers or cash dispensers using the coin hopper or cash dispensers to pay out values lower than a configured option amount. If the one or more coin hoppers or cash dispensers are empty, then all payouts come out as cashout voucher or ticket payouts printed by the NTS printer.

In another aspect, an NTS system control card is a main control card and it is operatively connected to a main communication bus, such as a serial communication bus used to implement a communications protocol such as such as a serial communications port implementing a protocol such as ccTalk, SAS or Xseries, in a gaming machine, such as an Amusement With Prize (AWP) gaming machine, and simulates a coin hopper or cash dispenser. The NTS system control card uses a real time clock to maintain date and time in the system.

In another aspect, an NTS system control card includes security features. If the NTS system control card does not see an NTS printer for a specified period of time, such as a few seconds, the NTS system control card performs a synchronization command to check that the NTS system control card is still talking to the same NTS printer unit. If the NTS printer is not the same NTS printer unit, the NTS system control card switches to coin hopper or cash dispenser payout until a configuration button of the NTS system control card is pressed and held for a period of time, such as 10 seconds, thus generating a new set of keys.

In another aspect, the functionality of the NTS system control card may be incorporated into the gaming machine controller, as either a control module or as program control instructions executed by the gaming machine controller.

In another aspect, the NTS system control card includes one configuration push-button functionality. For example, this functionality may include:

a) Holding the configuration button whilst applying power will cause the NTS system control card to instruct the NTS printer to print a test voucher or ticket with the configuration of both the NTS system control card and the NTS printer. This test voucher or ticket includes system date and time, a firmware version of both devices, and a unique identification number of the NTS system control card.

b) Clicking the NTS system control card configuration button a specified number of times, such as once, whilst the NTS system control card is powered will cause the NTS system control card to instruct the NTS printer to print out gaming machine audit data displaying an audit of a specified number of cashout voucher or ticket issues, such as the last 10 issues.

c) Clicking the NTS system control card configuration button a specified number of times again, such as once again within a specified period of time, such as 10 seconds, and the NTS printer will be instructed by the NTS system control card to print another specified number of records, such as records 10 to 20.

d) Double clicking the configuration button will cause the NTS system control card 1000 to instruct the NTS printer to print out all audit data and payout information in computer-readable indicia, such as a 2D barcode, which can be scanned into the redemption device, to maintain a record of all transactions.

e) Clicking the configuration button a specified number of times, such as 5 times, will cause the NTS system control card to instruct the NTS printer to re-print out all previous audit data ticket issued in the last 24 hours. Storing the data will protect the management from purposeful loss of tickets and possible shrinkage.

f) Holding the configuration button down for a specified interval of time, such as 10 seconds, will cause the NTS system control card and the NTS printer to generate new encryption keys.

### BRIEF DESCRIPTION OF THE DRAWINGS

These and other features and aspects of the present disclosure will become better understood with regard to the following description, accompanying drawings and appendix where:

FIG. 1 is a block diagram of an NTS system in accordance with the present disclosure;

FIG. 2 is a block diagram of another NTS system in accordance with the present disclosure;

FIG. 3a is an illustration of a cashout voucher or ticket in accordance with the present disclosure;

FIG. 3b is an illustration of the information that is encoded in printed indicia in accordance with the present disclosure;

FIG. 4 is a diagram of a NTS system control card in accordance with the present disclosure;

FIG. 5 is a diagram of another NTS system control card in accordance with the present disclosure;

FIG. 6 is a diagram of another NTS system control card in accordance with the present disclosure;

FIG. 7 is a sequence diagram depicting the operations of an NTS system when generating and redeeming a cashout voucher in accordance with the present disclosure;

FIG. 8 is a sequence diagram depicting the operation of an NTS system during an initialization procedure in accordance with the present disclosure;

FIG. 9 is a sequence diagram depicting the operation of an NTS system during an administrative task procedure in accordance with the present disclosure;

FIG. 10 is an architecture diagram of an NTS printer in accordance with the present disclosure;

FIG. 11 is an architecture diagram of an NTS controller in accordance with the present disclosure;

FIG. 12 is an architecture diagram of a redemption device in accordance with the present disclosure;

FIG. 13 is an architecture diagram of a redemption device in accordance with the present disclosure; and

APPENDIX A is an appendix including terms as used herein.

### DETAILED DESCRIPTION

A Networkless Ticketing Solution (NTS) is a system for providing a “ticket-out”, that is, a cashout voucher or ticket to a player, solution for a gaming machine without using a host system connected to the gaming machine via a network. An NTS system uses an encrypted cashout voucher or ticket as the vehicle for transferring validation for each voucher that is printed to cashout a player. This solution is aimed at the countless small site operations across the world that currently rely on coin hopper or cash dispensers as a monteans of payment or add a medium for payment where hand pay by a cashier is currently used.

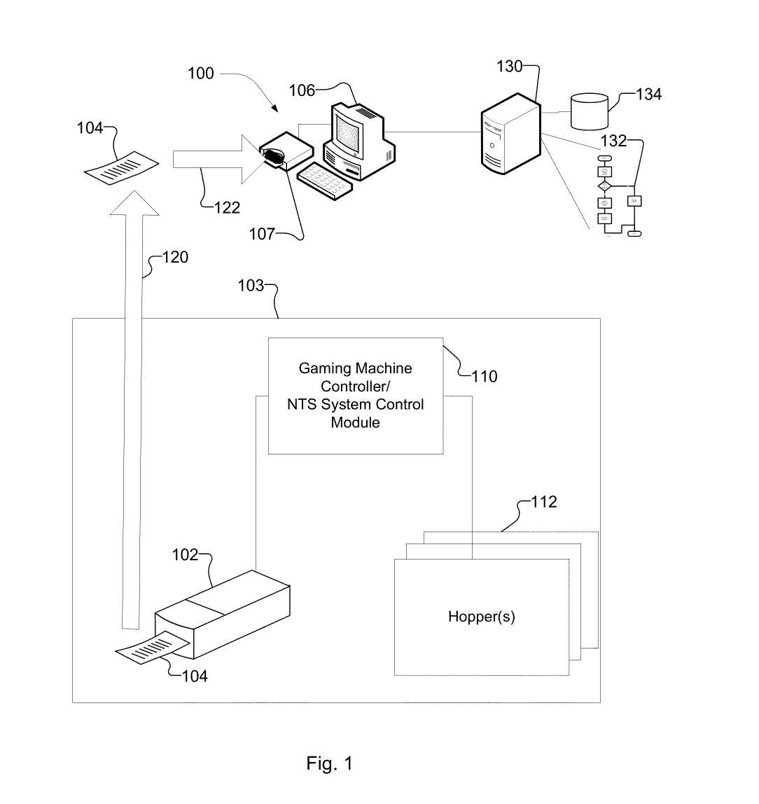

FIG. 1 is a block diagram of an NTS system in accordance with the present disclosure. An NTS 100 includes an NTS printer 102 that is associated with a gaming machine 103. The NTS printer 102 is operatively connected to a NTS system control module of gaming machine controller 110. When a cashout request is received by the gaming machine controller 110 from a player or customer, the NTS printer 102 is signaled to print out an encrypted cashout voucher or ticket 104 that is presented (120) to the customer. The customer takes (130) the printed cashout voucher or ticket 104 to a redemption terminal 106, such as a Point Of Sale (POS) terminal or Personal Computer (PC) at a bar or redemption counter, to exchange the cashout voucher or ticket 104 for cash. At the bar/redemption counter, computer-readable indicia, such as a 2D barcode on the cashout voucher or ticket 104, is scanned by a scanner 107 operatively connected to the redemption terminal 106. The redemption terminal 106 then transmits the scanned voucher information to a redemption device 130 running redemption decryption and validation program control instructions 122. The program control instructions 122 validate the cashout voucher or ticket 104 and instruct an operator of the gaming machine to present to the customer or player the correct cash based on the encrypted cashout voucher or ticket 104 data and a value printed on the cashout voucher or ticket 104. The program control instructions 122 may also store the cashout voucher or ticket 104 information in a database 124 so that the voucher or ticket 104 cannot be used again and to keep an audit of the gaming machine 103.

The redemption program control instructions 122 may include the following functionality:

a) Scans, decrypts, approves and credits cash out vouchers or tickets

b) Performs initial configuration for a NTS control card

c) Configures and sets up a Secure Digital (SD) or other flash memory device card

d) Collects and stores all audit data

e) Provides for Web based distribution of audit data

f) Designs and creates promotional and information tickets

g) Provides for Web based updates

It is possible that for low payouts the operators of the gaming machine will still want to pay out coinage. To do so, the control module of the gaming machine controller 110 is further operatively coupled to one or more coin hoppers or cash dispensers 112 and may act as a simulated slave and also act as a host to the one or more coin hopper or cash dispensers 112. The one or more coin hoppers or cash dispensers 112 are then used to pay out values lower than a configured option or even a combination of both coinage and vouchers or tickets. If the one or more coin hoppers or cash dispensers are empty then all payouts come out as cashout voucher or ticket payouts printed by the NTS printer 102.

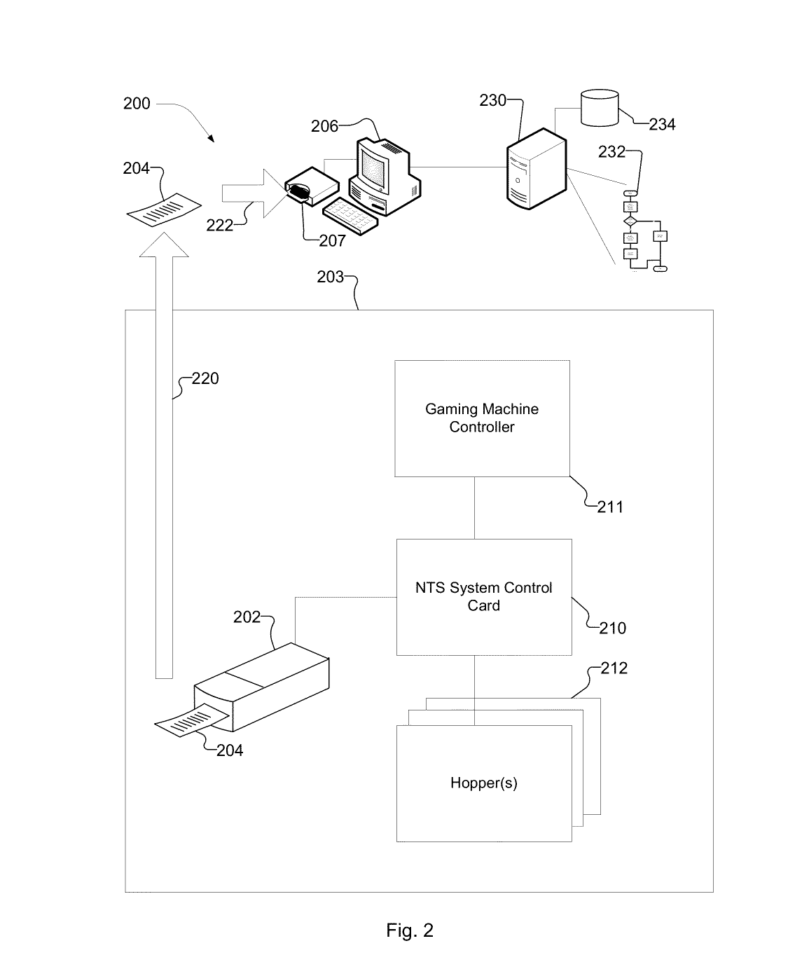

FIG. 2 is a block diagram of another NTS system in accordance with the present disclosure. An NTS 200 includes an NTS printer 202 that is associated with a gaming machine 203. When a cashout request is received by the gaming machine 203 form a player or customer, the NTS printer 202 is signaled to print out an encrypted cashout voucher or ticket 204 that is presented (220) to the customer. The customer takes (230) the printed cashout voucher or ticket 204 to a redemption terminal 206, such as a Point Of Sale (POS) terminal or Personal Computer (PC) at a bar or redemption counter, to exchange the cashout voucher or ticket 204 for cash. At the bar/redemption counter, computer-readable indicia on the cashout voucher or ticket 204, such as a 2D barcode, will be scanned by a scanner 207 operatively connected to the redemption terminal 206. The redemption terminal 207 will transmit the scanned voucher information to a redemption device 230 executing redemption decryption and validation program control instructions 232. The program control instructions 232 will validate the cashout voucher or ticket 204 and instruct an operator of the gaming machine to present to the customer or player the correct cash based on the encrypted cashout voucher or ticket 204 data and a value printed on the cashout voucher or ticket 204. The program control instructions 232 also store the cashout voucher or ticket 204 information in a database 234 so a scanned voucher cannot be used again and to keep an audit of the gaming machine 203. In addition, the program control instructions 208 may further include all of the features and functionality of the program control instructions 132 of FIG. 1.

It is possible that, for low payouts, the operators of the gaming machine will still want to pay out currency such as coinage, to gain market acceptance coin hopper or cash dispenser payout may also be performed. To do this, a NTS system control card 210 operatively coupled to a gaming machine controller 211 of the gaming machine will not only act as a simulated slave it will also act as a host to one or more coin hoppers or cash dispensers 212 using them to pay out values lower than a configured option or even a combination of both coinage and vouchers or tickets. If the one or more coin hoppers or cash dispensers 212 are empty, then all payouts come out as cashout voucher or ticket payouts printed by the NTS printer 202.

In one aspect, an NTS printer is operatively connected to an NTS system control card and not the game. Therefore, older non-cashless games become compatible by supporting EFT or AFT.

In another aspect, the NTS printer is side-mounted so it can be attached to equipment that does not have provision for a ticket printer.

In another aspect, a redemption terminal may be operatively coupled to a redemption device using Web-based communications such as using a HTTPS protocol or the like. Accordingly, the redemption terminal may communicate with the redemption device via a Local Area Network (LAN), Wide Area Network (WAN), Virtual Private Network (VPN) or the like. In accordance with this aspect, one or more redemption terminals may be operatively coupled to a single redemption device via a network. By virtue of operatively connecting one or more redemption terminals to a single redemption device, a vendor may deploy NTS systems at more than one location and service those locations over the network.

In another aspect, a redemption terminal and a redemption device may be incorporated into the same device.

The foregoing description of features, aspects and functions of an NTS system are to be understood as illustrative only. Those skilled in the art of gaming systems will recognize that the features, aspects and functions described or not mutually exclusive and may be deleted and/or combined with other features, aspects and functions described herein or known in the art as may suit a particular implementation or purpose.

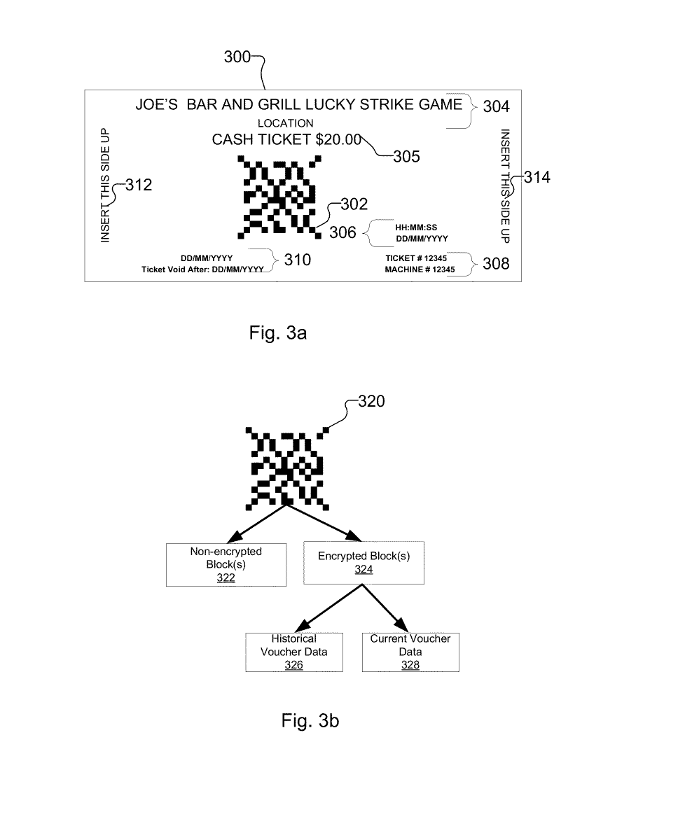

FIG. 3a is an illustration of a cashout voucher or ticket in accordance with the present disclosure. A cashout voucher or ticket 300 includes one or more computer-readable indicia, such as a 2D barcode 302. The one or more computer-readable indicia encode encrypted validation and cashout data that is used to validate the cashout voucher or ticket 300 and determine an amount of currency that should be paid out to a customer or player. It should be understood that any computer-readable indicia may be used, such as one or more 1D barcodes, one or more 2D barcodes, optically recognizable characters, etc. The cashout voucher or ticket 300 may further include human-readable indicia for reading by a customer or player, such as location information and game information 304, cashout value 305 in numbers or in words, date and time information 306, cashout voucher or ticket identifiers that are independent of the encrypted data and gaming machine or NTS system control card identifier 308, redemption period information 310, and instructions to the customer or player on how to manipulate the cashout voucher or ticket 312 and 314. In addition, the cashout voucher or ticket may include advertising or promotional information such as coupon information (not shown.)

In one aspect, the computer-readable indicia may include non-encrypted voucher or ticket data as well.

FIG. 3b is an illustration of computer-readable indicia that may be printed on a voucher or ticket in accordance with the present disclosure. The computer-readable indicia includes one or more encrypted blocks 324 of doubly encrypted voucher or ticket data. The one or more encrypted blocks include historical voucher or ticket data 326 about one or more vouchers or tickets that were previously printed by a NTS system in accordance with the present disclosure. In addition, the one or more encrypted blocks 324 include encrypted voucher or ticket data 328 for a current voucher.

In one aspect, the computer-readable indicia 320 may include one or more non-encrypted data blocks 322 containing voucher data that may or may not be printed on the voucher in human-readable form, such as location information, game being played, etc.

In another aspect, the historical voucher data 326 and current voucher data 328 include a date and time-of-day that a voucher or ticket were printed.

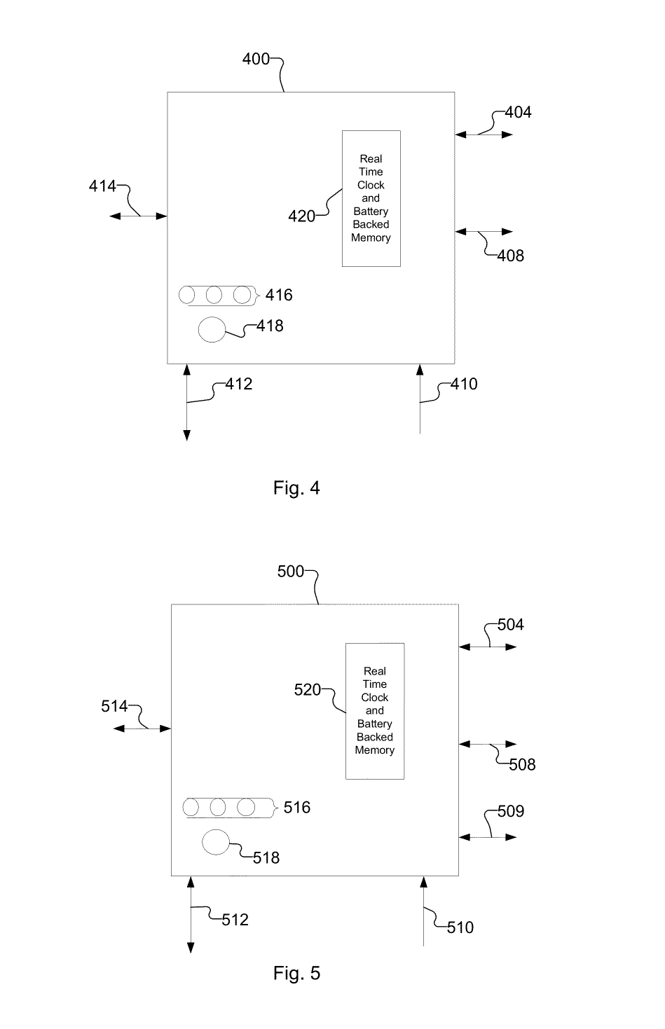

FIG. 4 is a diagram of an NTS system control card in accordance with the present disclosure. An NTS system control card 400 includes a communications interface, such as RS232 port 404, operative to connect the NTS system control card 400 to a printer. The NTS system control card 400 also includes a communications interface or port 408, such as a serial communications port implementing a protocol such as ccTalk, SAS or Xseries, operative to connect the NTS system control card 400 to a coin hopper or cash dispenser. The NTS system control card 400 also includes a Secure Digital (SD) or other flash memory device card reader 410. The NTS system control card 400 may also include a programming interface 412 for programming the NTS system control card 400. The NTS system control card 400 may also include a communication interface allowing the NTS system control card 400 to be a slave device in a gaming machine control network, such as a serial communications port implementing a protocol such as ccTalk, SAS or Xseries slave port 414. The NTS system control card 400 also includes a user input interface, such as a configuration button 418, to allow the NTS system control card 400 to receive user inputs for configuration and one or more user output interfaces, such as LED status indicators 416 for indicating the status of the NTS system control card 400. In addition, each communications interface may include one or more status indicators (not shown). The NTS system control card 400 also includes a real time clock and battery backed memory 420.

FIG. 5 is a diagram of another NTS system control card in accordance with the present disclosure. An NTS system control card 500 includes a communications interface, such as RS232 port 504, operative to connect the NTS system control card 500 to a printer. The NTS system control card 500 also includes a communications interface or port 508, such as a serial communications port implementing a protocol such as ccTalk, SAS or Xseries, operative to connect the NTS system control card 500 to a coin hopper or cash dispenser. The NTS system control card 500 also includes a communications interface, such as RS232 ID003 bill validator port 509, for operatively connecting the NTS system control card 500 to a bill validator. The NTS system control card 500 also includes a Secure Digital (SD) or other flash memory device card reader 510 for loading configuration information. The NTS system control card 500 may also include a programming interface 512 for programming the NTS system control card 500. The NTS system control card 500 may also include a communication interface allowing the NTS system control card 500 to communicate on a gaming machine control network, such as ccTalk, SAS or Xseries port 514. The NTS system control card 500 also includes a user input interface, such as a configuration button 518 to allow the NTS system control card 500 to receive user inputs for configuration and one or more user output interfaces, such as LED status indicators 516 for indicating the status of the NTS system control card 500. In addition, each communications interface may include one or more status indicators (not shown). The NTS system control card 500 also includes a real time clock and battery backed memory 520.

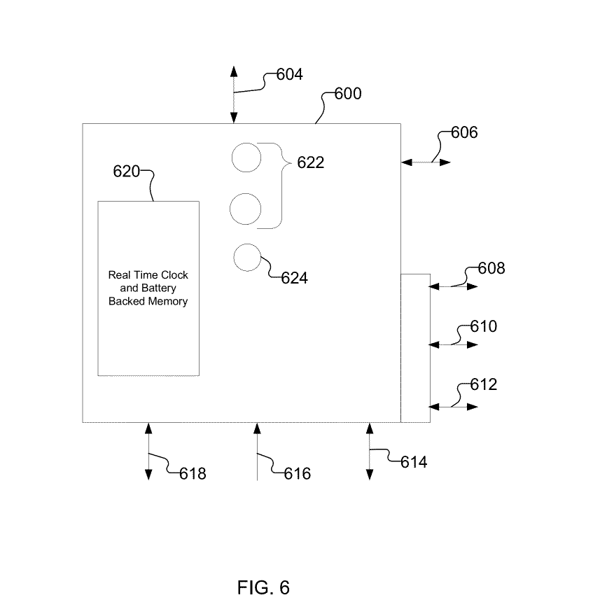

FIG. 6 is a diagram of another NTS system control card in accordance with the present disclosure. An NTS system control card 600 includes a communications interface, such as RS232 port 604, operative to connect the NTS system control card 600 to a printer. The NTS system control card 500 also includes a communications interface, such as ccTalk, SAS or Xseries port 606 operative to connect the NTS system control card 600 to one or more coin hoppers or cash dispensers.

The NTS system control card 600 also includes one or more communication interfaces that are used to expand the functionality of the NTS system control card 600 for full Ticket-In Ticket-Out (TITO) functionality. Accordingly, the NTS system control card 600 includes an RS232 port 608 for operatively connecting the NTS system control card 600 to a reader for reading computer-readable indicia on a cashout voucher or ticket, such as a bar code reader or the like. In addition, the NTS system control card 600 includes a communications interface for operatively connecting the NTS system control card 600 to a coin currency acceptor, such as RS232 port 610 for a coin acceptor. The NTS system control card 600 further includes a communications interface, such as RS232 port 612, for operatively connecting the NTS system control card 600 to a paper currency acceptor such as a bill validator.

The NTS system control card 600 also includes a Secure Digital (SD) or other flash memory device card reader 616 for loading configuration information. The NTS system control card 600 may also include a programming interface 614 for programming the NTS system control card 600. The NTS system control card 600 may also include a communication interface allowing the NTS system control card 600 to communicate on a gaming machine control network, such as ccTalk, SAS or Xseries port 618.

The NTS system control card 600 also includes a user input interface, such as a configuration button 624 to allow the NTS system control card 600 to receive user inputs for configuration and one or more user output interfaces, such as LED status indicators 622 for indicating the status of the NTS system control card 600. In addition, each communications interface may include one or more status indicators (not shown). The NTS system control card 600 also includes a real time clock and battery backed memory 624.

In another aspect, an NTS system control card and associated printer are powered separately from a gaming machine's main power supply.

In another aspect, an NTS system control card may be integrated into a gaming machine controller as a control module and/or program control instructions. In such a construction, the gaming machine controller performs the functions of the NTS system control card.

In another aspect, a user interface of an NTS system control card includes multiple LEDs and status indicators. For example, such an NTS system control card may have one multi function, 3 general status LEDs (Red, Amber, Green) and a status LED to indicate the status of each interface.

In another aspect, each connection status interface of an NTS system control card may have a dedicated green LED, that flashes (such as one second off and 0.5 seconds on) if the interface is configured and ready to use, once communication is established the LED blinks rapidly until the NFT control is in a stable mode (simply polling or being polled). When data other than simple polls are communicated, the LED will flash rapidly again.

In another aspect, an NTS system control card signals external control of a bezel LED and introduces flash codes for the NTS system control card. To indicate a problem, the NTS system control card sends a command to get the bezel LED to operate in a particular way.

Accordingly, such user interface features will enable an installer to see if an incorrect configuration has been used and which connectors should be connected to easily identify problems.

In another aspect, an NTS system control card is a main control card and it is operatively connected to a main ccTalk, SAS or Xseries bus in an Amusement With Prize (AWP) gaming machine and simulates a coin hopper or cash dispenser. The NTS system control card uses a real time clock to maintain date and time in the system.

In another aspect, the NTS system control card may include five RS232 ports:

1) Printer connection TCL using an updated set of commands. This port is combined with 24VDC to power the printer.

2) ccTalk, SAS or Xseries slave connection to simulate one or more coin hoppers or cash dispensers

3) ccTalk, SAS or Xseries master Connection

4) ID0003 bill validator port for TITO expansion

5) Spare port

In another aspect, the NTS system control card may also include a configuration/download port, for example a USB port. If the configuration/download port is a USB the NTS system control card is USB powered for download and configuration.

In another aspect, configurable items of the NTS system control card include the name of an establishment, game name, number of coin hoppers or cash dispensers to simulate, coin hopper or cash dispenser payout enabled, coin hopper or cash dispenser payout trigger, and maximum ticket payout, among others.

In another aspect, when an NTS system control card is connected to a redemption device running the redemption program control instructions, the date and time on the NTS system control card will be automatically updated

In another aspect, the NTS system control card includes an SD configuration slot. This is a read only port used for downloading new program control instructions or settings while in a gaming machine. This slot also be used a security key if the operators of the gaming machine are concerned about initialization of keys or other operations.

In another aspect, the SD card downloads setup offers, promotions, or news about the establishment to print out at the same time as cashout vouchers or tickets.

In another aspect, an NTS system control card includes I/O channels (not shown). For example, the NTS system control card is provisioned with 3 input and 3 output channels spec such as External warning LED or door switch have to be introduced.

In another aspect, an NTS system control card is mounted inside a gaming machine, as close to the serial communication port, such as a serial communication pport utilizing a protocoal such as ccTalk, SAS, Xseries or the like, as possible. The street market is prone to constant attack from fraud of various kinds. To help prevent this, the NTS system control card is encased in the same plastic housing as a routing device. The routing device can be mounted to a c-shaped, ground-able, metal mounting plate that protects the device from ESD, physical, and tamper abuse.

In another aspect, an NTS system control card includes power down detection circuitry. As with typical cash handling gaming devices, the NTS control board is able to detect power failure and have enough stored energy to poll all devices and store the setting to battery backed memory before power fails completely.

In another aspect, an NTS system control card includes a real time clock and rechargeable battery backed memory to store the date (for example, in DD/MM/YYYY format), time (such as a 24 hour clock), unique card identification number (to identify the unit the ticket out), audit data for all transactions since the last report printed, back up of the last audit data sent to an NTS printer, current encryption key, and audit information, among others.

In another aspect, the NTS system control card includes audit capabilities. By monitoring all communication traffic on the slave bus, the NTS system control card can build up a complete cash-in and cash-out record from the machine, and total cash. The type of coins and notes paid in and paid out through both tickets and coins can be determined. All this information can be recorded and some of the information permanently.

In another aspect, an NTS system control card includes various security features. For example, f the NTS system control card is unable to communicate with an NTS printer for a specified period of time, such as a few seconds, the NTS system control card performs a synchronization command to check that the NTS system control card is still talking to the same NTS printer unit. If the NTS printer is not the same NTS printer unit, the NTS system control card switches to coin hopper or cash dispenser payout until a configuration button of the NTS system control card is pressed and held for a period of time, such as 10 seconds, thus generating a new set of keys that can then be used by the NTS system control card and NTS printer.

In another aspect, an NTS system control card includes key generation capabilities such as an internal processor cycle count and time stamped based encryption.

In another aspect, an NTS system control card acts as a system host leading the gaming machine to believe it is connected to a full TITO system and performing an EFT/AFT deduction in the event of a cashout. There is no coin hopper or cash dispenser requirement for this set up. By connecting the cashout button to the I/O port, an gaming machine operator could actually connect non-TITO machines to be ticket-out only or full function TITO gaming machines.

In another aspect, an NTS system includes a computer-readable indicia reader, such as a 2D barcode scanner, to read cashout vouchers or tickets printed from the gaming machine associated NTS system equipment.

The foregoing description of features, aspects and functions of an NTS system control card are to be understood as illustrative. Those skilled in the art of gaming systems will recognize that the physical features, aspects and functions described herein are not mutually exclusive and may be deleted and/or combined with other features, aspects and functions as described herein or known in the art as may suit a particular implementation or purpose.

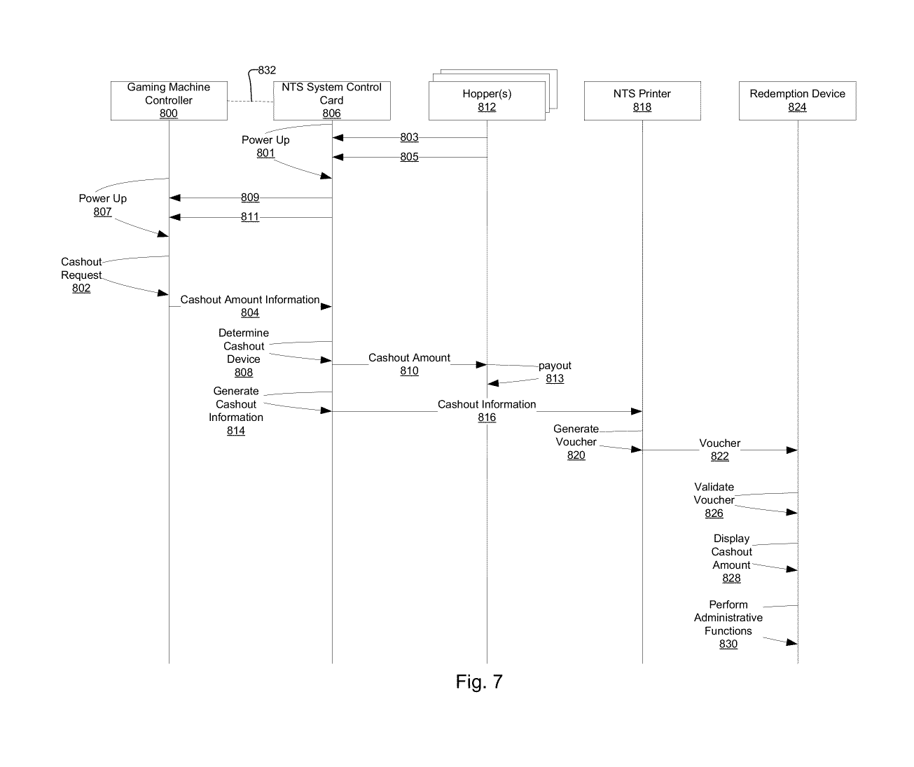

FIG. 7 is a sequence diagram depicting the operations of an NTS system when generating and redeeming a cashout voucher in accordance with the present disclosure. On power-up (801) the NTS system control card 806 polls one or more coin hoppers or cash dispensers 812 using an encrypted communications protocol, such as a serial protocol such as ccTalk, SAS or Xseries, and stores the received coin hopper or cash dispenser data, such as coin hopper or cash dispenser data 803 and 805, received from the polled coin hoppers or cash dispensers 812. It is possible there may be more than one coin hopper or cash dispenser associated with the gaming machine so the NTS system control card 806 will recognize this and collect the data from all of the coin hoppers or cash dispensers 812. Once a gaming machine controller 800 controlling a gaming machine (not shown) associated with the NTS system is powered up and starts to poll for coin hoppers or cash dispensers on the main communication bus, the NTS system control card 806 will have all the information ready and will begin to answer, such as answers 809 and 811, as if the NTS system control card 806 were the existing coin hoppers or cash dispensers 812, thus spoofing the coin hoppers or cash dispensers 812 to the gaming machine. In normal operation the NTS system control card 806 will respond to all polls sent to the coin hoppers or cash dispensers and the NTS system control card 806 will also monitor all other communications traffic during operation of the gaming machine (not shown) and collect any data relevant for auditing purposes.

When the gaming machine controller 800 receives a cashout request (802) from a customer or player of the gaming machine (not shown) controlled by the gaming machine controller 800, the gaming machine controller (800) determines a cashout amount and transmits cashout information 804, including coin hopper or cash dispenser payout information, to the NTS system control card 806. If a coin hopper or cash dispenser payout is detected on the ccTalk, SAS or Xseries bus, the NTS system control card will respond to the gaming machine controller as coin hoppers or cash dispensers 812 would, thus further spoofing coin hoppers or cash dispensers 812 to the gaming machine (not shown) controlled by the gaming machine controller 800.

In one aspect, as described herein, an operator of the gaming machine (not shown) controlled by the gaming machine controller 800 may want small payouts to be made using coin hoppers or cash dispensers 812. If so, the NTS system control card 806 makes a determination (808) of whether to use the coin hoppers or cash dispensers 812 or an NTS printer 818 to make the payout based on an amount of the cashout amount. If it is determined that the coin hoppers or cash dispensers 812 are to be used, the NTS system control card signals the cashout amount 810 to one or more of the coin hoppers or cash dispensers 812 and the coin hoppers or cash dispensers 812 make (813) the payout in currency to the customer or player of the gaming machine (not shown) controlled by the gaming machine controller 800.

If the NTS system control card 806 determines that the payout is to be made using the NTS printer 818, the NTS system control card generates (814) encrypted cashout information 816 for cashout voucher or ticket validation, along with an encrypted checksum and communicates the cashout information 816 to the NTS printer 818.

The NTS printer 818 receives the encrypted information and the checksum and encrypts the encrypted information again. The NTS printer encodes the doubly encrypted information into a computer-readable indicia, such as a 2D barcode, used to generate (820) a cashout voucher or ticket, and prints the computer-readable indicia and cashout voucher or ticket information onto a cashout voucher or ticket 822 for presentation to the customer or player of the gaming machine (not shown) controlled by the gaming machine controller 800.

The customer or player takes the cashout voucher or ticket 822 and scans the voucher or ticket 822 in a scanner of a redemption terminal (not shown) which transmits the scanned cashout voucher or ticket data to a redemption device 824. The redemption device receives the scanned cashout voucher or ticket data from the redemption terminal (not shown), and redeems the voucher or ticket 822 by validating (826) the voucher 822. For example, a cashier scans the computer-readable indicia, such as a 2D barcode, on the cashout voucher or ticket into the redemption device 824 using the redemption terminal (not shown). Program control instructions of the redemption device 824 double decrypt the information in the computer-readable indicia, such as a 2D barcode, using encryption keys that have been registered with the NTS printer and NTS System control system, confirm the cashout voucher or ticket 822 is a valid cashout voucher or ticket, and display (828) the previously encrypted value of the ticket. This value will be displayed on a display accessible by the cashier, and the cashier will check the amount on the ticket is the same as the amount of display and pay the customer the value. After the redemption device 824 processes the cashout voucher or ticket 822, the redemption device performs (830) any administrative functions, such as recording the cashout information and cashout voucher or ticket identifier in a database for auditing purposes.

In one aspect, the NTS system control card 806 sends additional data along with encrypted data to print on a non-encrypted portion of a cashout voucher or ticket.

In another aspect, a real time clock of an NTS system control card is used to store date and time information that will be displayed on the cash out voucher or ticket.

In another aspect, a real time clock of an NTS system control card is used to compile detailed audit data regarding the vouchers or tickets being processed by the NTS system.

In another aspect, a real time clock of an NTS system control card is used to create encryption for one or more encryption or decryption keys.

In another aspect, and as described herein, the functionality of the NTS system control card 806 may be incorporated into the gaming machine controller 800, as indicated by dashed line 832, as either a control module or as program control instructions executed by the gaming machine controller 800.

In another aspect, as described herein, the NTS system control card 806 simulates, or spoofs, the one or more coin hoppers or cash dispensers 812 on a ccTalk, SAS or Xseries bus. When the NTS system control card 806 detects a payout request, the NTS system control card 806 will send cashout information 816 as a print string to the NTS printer 818 with an encrypted section of a message and an encrypted check sum. The NTS printer 818 will then generate (820) a cashout voucher or ticket 822 by encrypting the message into computer-readable indicia, such as a 2D barcode, and printing the cashout voucher or ticket 822 with the encrypted information.

In another aspect, only one encryption is performed by the NTS system control card 806. According to this aspect, the NTS printer 818 does not perform an encryption before generating (820) the cashout voucher or ticket 822.

In another aspect, only one encryption is performed by the NTS printer 818. According to this aspect, the NTS system control card 806 does not encrypt the cashout information 816 before the cashout information 816 is sent to the NTS printer 818.

In another aspect, a two key system is used having private and public keys, for encrypting and decrypting, respectively, the cashout information 816 or the computer-readable indicia printed onto the cashout voucher or ticket 822. According to this aspect, the keys that are transferred to, stored by, and used by the redemption device are the public keys. In addition, the NTS system control card 806 and the NTS printer 818 are responsible for generating their respective private and public key pairs.

In another aspect, only one encryption is performed by the NTS system control card 806 using a private key. According to this aspect, the NTS printer 818 does not perform an encryption before generating (820) the cashout voucher or ticket 822. In addition, the redemption device 824 uses a public key supplied by the NTS system control card 806 to decrypt the cashout voucher or ticket 822.

In another aspect, only one encryption is performed by the NTS printer 818 using a private key. According to this aspect, the NTS system control card 806 does not encrypt the cashout information 816 before the cashout information 816 is sent to the NTS printer 818. In addition, the redemption device 824 uses a public key supplied by the NTS printer 818 to decrypt the cashout voucher or ticket 822.

In another aspect, the redemption device 824 is incorporated into a redemption terminal.

In another aspect, the redemption device 824 is also a POS terminal, thus allowing the redemption device to not only display 828 the cashout information to a cashier, but also ring out the cashout amount to the cashier or payout the cashout amount directly to the customer or player.

In another aspect, a redemption terminal includes a display that is used to display the cashout information to a cashier. According to this aspect, the redemption device transmits the cashout information decrypted from the computer-readable indicia to the redemption device for display.

In another aspect, and as described herein, the functionality of the NTS system control card 806 may be incorporated into the gaming machine controller 800 as either a control module or as program control instructions executed by the gaming machine controller 800 (as indicated by dashed line 832)

In another aspect, the voucher or ticket information that is encrypted and encoded in computer-readable indicia includes both current voucher or ticket data and historical voucher or ticket data for one or more vouchers or tickets that were printed by the NTS system control card 806 using the NTS printer 818. The historical voucher or ticket data may be used in a validation process for the current voucher or ticket data. To do so, the redemption device 824 compares the historical voucher or ticket data stored on the voucher in the encrypted computer-readable indicia to redemption voucher or ticket data stored by the redemption device 824 for previously redeemed vouchers or tickets. If the historical voucher or ticket data matches, either completely or partially, the redemption voucher or ticket data that has been previously stored, a presumption of validity of the voucher or ticket will be stronger. However, if the historical voucher or ticket data fails to match, either completely or partially, the redemption voucher or ticket data that has been previously stored, a presumption of validity of the voucher or ticket will be weaker. If the presumption of validity is strong, the current voucher or ticket may then be validated. If the presumption is weak, the current voucher or ticket may be invalidated.

In another aspect, the NTS system control card receives one or more player instructions to determine a cashout amount to print on a voucher or ticket. According to this aspect, the NTS system control card receives an intermittent cashout signal, such as a signal generated by a player pressing and then releasing a cashout button located on an exterior surface of a gaming machine associated with the NTS system control card, indicating that the player is requesting a cashout. Upon reception of a first intermittent cashout signal, the NTS system control card determines a standard cashout amount should be printed onto the cashout voucher, for example, 5 units of credit. While the NTS system control card continues to receive intermittent signals, the NTS system control card continues to accumulate cashout amounts in increments of the standard cashout amount. When no more intermittent signals are received for a period of time, the NTS system control card then instructs the NTS printer to print the accumulated cashout amount as described herein. Alternatively, if the NTS system control card receives a continuous cashout signal, such as a signal generated by a player pressing and then continuously holding down the cashout button, for a specified period of time, such as 5 seconds, the NTS system control card determines that the player is requesting a complete cashout and generates a cashout voucher or ticket of the appropriate cashout amount.

In another aspect, a NTS system control card receives a series of cashout amounts from a gaming machine controller. The NTS system control card accumulates the cashout amounts for a period of time until the NTS system control card receives a signal from the gaming machine controller to cashout the player. In response to the cashout signal, the NTS system control card instructs the NTS printer to print a cashout voucher or ticket for the accumulated cashout amount. In another aspect, the cashout signal is received by the NTS system control card from the player using a cashout button or the like mounted on an exterior surface of a gaming machine associated with the NTS system control card.

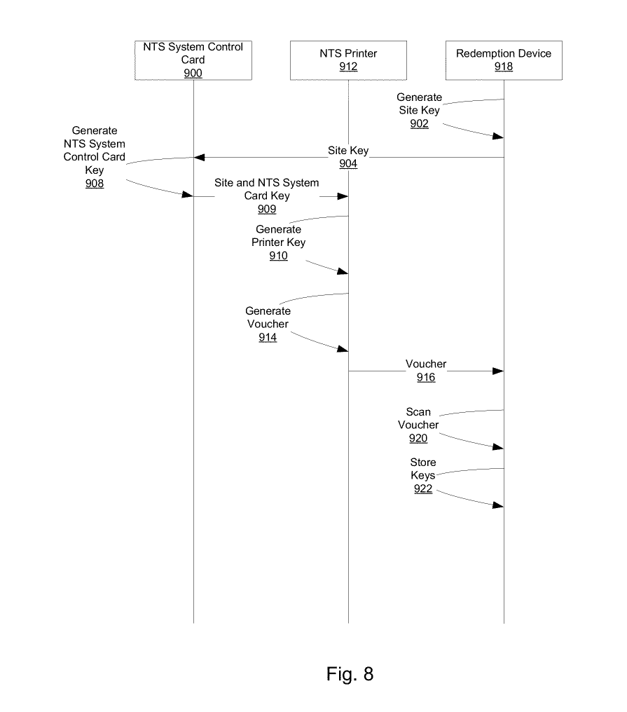

FIG. 8 is a sequence diagram depicting the operation of an NTS system during an initialization procedure in accordance with the present disclosure. As described herein, an NTS system control card 900 may receive (not shown) operator inputs specifying what functions the NTS system control card 900 should perform during an initialization process.

In another aspect of initialization, the NTS system control card 900 is operatively connected to the redemption device 918. The redemption device generates (902) a site key 904. The redemption device stores the site key for later use. The redemption device 918 transmits the site key to the NTS system control card 900. The NTS system control card 900 sends the site key 904 to an NTS printer 912. The NTS system control card generates 908 an encryption key that the NTS system control card will use to encrypt voucher or ticket data that is sent the NTS printer 912. The NTS printer 912 receives the site key and the NTS system control card key 909 from the NTS system control card. The NTS printer 912 generates (910) an encryption key that the NTS printer 912 will use to perform a second encryption as described herein. The NTS printer 912 uses the site key to encrypt the NTS system control card key and the NTS printer key. The NTS printer 912 then generates (914) a voucher or ticket 916 that includes the two encrypted keys in computer-readable indicia as described herein. The voucher or ticket 916 is then scanned into the redemption device using a redemption terminal (not shown) as previously described herein. The redemption device decrypts the encrypted computer-readable indicia to recover the NTS system control card key and the NTS printer key using the site key and stores the decrypted keys for later use in validating vouchers or tickets as described herein.

In one aspect, an NTS system control card and a redemption server are operatively connected for the initialization process and are disconnected after the initialization process. For example, the NTS system control card can be removably mounted within an associated gaming machine thus allowing the NTS system control card to be detached from the gaming machine and taken to the redemption device to receive a site key. The NTS system control card is then replaced in the gaming machine so that the NTS printer and the NTS system control card may exchange the site key and NTS system control card key as described herein.

In another aspect, the NTS system control card may receive the site key from the redemption device via removable computer-readable media, such as an SD card, USB flash drive or the like.

In another aspect, the NTS system control card and the NTS printer generate new NTS system control card and NTS printer keys when instructed to do so by an operator. The keys are generated without any additional communication between the NTS system control card and a redemption device. To exchange the newly created NTS system control card key and the NTS printer key, the keys are doubly encrypted as voucher information would be and printed on a voucher or ticket as computer-readable indicia as described herein. The computer-readable indicia on the resultant voucher or ticket is then scanned into, and decrypted by, the redemption device as described herein in order to recover the new keys.

In another aspect, an NTS system control card and a redemption device exchange one or more keys that the NTS system control card and NTS printer will use for encrypting voucher information as described herein. The keys are held by the NTS system control card and the redemption device. When instructed to do so by an operator, the NTS system control card and NTS printer generate respective new keys using the stored keys that were previously generated and exchanged by the NTS system control card and the redemption device. In accordance with this aspect, the NTS system control card and the NTS printer may only exchange a portion of the generated new keys in the form of encrypted computer-readable indicia. The portion of the generated new keys uniquely identifies the new keys to the redemption device. In addition, one or more indexes identifying the stored keys that are now being used by the NTS system control card and the NTS printer may be used instead of the unique portion of the keys. When the redemption device receives the unique portion of the keys or the one or more indexes, the redemption device uses the unique portion or the indexes to determine which of the previously generated and stored keys are now being used by the NTS system control card and the NTS printer to generate encrypted vouchers and tickets as described herein.

In another aspect, only one encryption is performed by the NTS system control card 900. According to this aspect, the NTS printer 912 does not perform an encryption before generating a cashout voucher or ticket. In addition, the voucher or ticket 916 generated by the NTS printer and scanned by the redemption device 918 contains only a single encryption key, namely that of the NTS system control card 900.

In another aspect, only one encryption is performed by the NTS printer 912. According to this aspect, the NTS system control card 900 does not encrypt cashout information before the cashout information is sent to the NTS printer 912. In addition, the voucher or ticket 916 generated by the NTS printer and scanned by the redemption device 918 contains only a single encryption key, namely that of the NTS printer 912.

In another aspect, a two key system is used having private and public keys, for encrypting and decrypting, respectively, cashout information or computer-readable indicia printed onto cashout voucher or ticket. According to this aspect, the keys that are transferred to, stored by, and used by the redemption device are the public keys of the NTS system control card 900 and NTS printer 912. In addition, the NTS system control card 900 and the NTS printer 912 are responsible for generating their respective private and public key pairs.

In another aspect, only one encryption is performed by the NTS system control card 900 using a private key. According to this aspect, the NTS printer 912 does not perform an encryption before generating a cashout voucher or ticket. In addition, the key 910 supplied by the NTS system control card 900 to the redemption device 918 is a public key used to decrypt a cashout voucher or ticket.

In another aspect, only one encryption is performed by the NTS printer 912 using a private key. According to this aspect, the NTS system control card 900 does not encrypt cashout information before the cashout information is sent to the NTS printer 912. In addition, the redemption device 918 uses a public key supplied by the NTS printer 912 to decrypt a cashout voucher or ticket.

In another aspect, as part of the generation process 914, the NTS printer 912 may use a randomly chosen new computer-readable indicia, encryption key. The NTS printer 912 randomly chooses an encryption key for encryption of data received from the NTS system control card 900 and prints the key along with the rest of the ticket in a computer-readable indicia, such as a 2D barcode. The NTS printer 912 may further include the functionality to randomly update the encryption key and to print the keys.

In another aspect, when requested by the NTS system control card 900, the NTS printer 912 will generate a new encryption key. For example, the current cycle count is based on an incremented process cycle counter which is loaded and saved into flash memory at power up or down. The NTS printer 912 will simply confirm to the NTS system control card 900 that a new key is generated and with the information the NTS system control card 900 passed in the initial instruction, has printed a new control ticket.

In another aspect, and as described herein, the functionality of the NTS system control card 900 may be incorporated into a gaming machine controller (not shown) as either a control module or as program control instructions executed by the gaming machine controller (not shown).

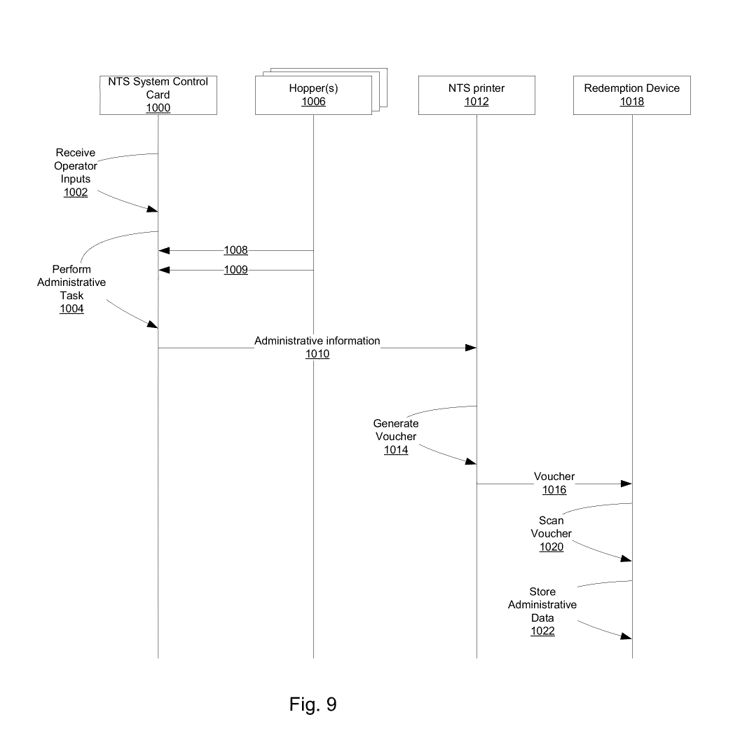

FIG. 9 is a sequence diagram depicting the operation of an NTS system during an administrative task procedure in accordance with the present disclosure. To perform an administrative procedure, the NTS system control card 1000 receives (1002) operator inputs from an operator of a gaming machine (not shown) associated with an NTS system. In response to the operator inputs, the NTS system control card performs (1004) an administrative task that may include polling one or more coin hoppers or cash dispensers (1006) including in the gaming machine (not shown). In response to the polling, the one or more coin hoppers or cash dispensers (1006) transmit coin hopper or cash dispenser data, such as coin hopper or cash dispenser data 1008 and 1009, to the NTS system control card 1000. The NTS system control card may also collect other administrative information and transmits the administrative information 1010 to an NTS printer 1012.

In response, the NTS printer generates 1014 a voucher or ticket 1016 containing the administrative information in computer-readable indicia that is then scanned (1020) by a redemption device 1018. The redemption device 1018 then stores (1022) the administrative data for further processing as described herein.

In one aspect, the NTS system control card 1000 includes one configuration push-button functionality. For example, this functionality may include:

a) Holding the configuration button whilst applying power will cause the NTS system control card 1000 to instruct the NTS printer 1012 to print a test voucher or ticket with the configuration of both the NTS system control card 1000 and the NTS printer 1012. This test voucher or ticket includes system date and time, a firmware version of both devices, and a unique identification number of the NTS system control card 1000.

b) Clicking the NTS system control card configuration button a specified number of times, such as once, whilst the NTS system control card is powered will cause the NTS system control card 1000 to instruct the NTS printer 1012 to print out gaming machine audit data displaying an audit of a specified number of cashout voucher or ticket issues, such as the last 10 issues.

c) Clicking the NTS system control card configuration button a specified number of times again, such as once again within a specified period of time, such as 10 seconds, and the NTS printer 1012 will be instructed by the NTS system control card 1000 to print another specified number of records, such as records 10 to 20.

d) Double clicking the configuration button will cause the NTS system control card 1000 to instruct the NTS printer 1012 to print out all audit data and payout information in computer-readable indicia, such as a 2D barcode, which can be scanned (1020) into the redemption device 1018, such as a PC as described herein, to maintain a record of all transactions.

e) Clicking the configuration button a specified number of times, such as 5 times, will cause the NTS system control card 1000 to instruct the NTS printer 1012 to re-print out all previous audit data ticket issued in the last 24 hours. Storing the data will protect the management from purposeful loss of tickets and possible shrinkage.

f) Holding the configuration button down for a specified interval of time, such as 10 seconds, will cause the NTS system control card 1000 and the NTS printer 1012 to generate new encryption keys as described herein.

In another aspect, if the NTS printer 1012 and the NTS system control card 1000 lose communication for a specified period of time, such as a second, a new synchronization will be used to check that it is the same NTS system control card and NTS printer talking to each other. This process may also take place when there is a power failure.

In another aspect, both the NTS system control card 1000 and the NTS printer 1012 generate encryption keys internally using random number generator. Holding the configuration button down for as specified amount of time, such as 15 seconds, causes the NTS system control card 1000 to generate new number which is encrypted and sent to the NTS printer 1012. A voucher or ticket is printed with both keys in computer-readable indicia, such as a 2D barcode. The computer-readable indicia is then scanned 1020 by the redemption device 1018 to register the new keys.

In another aspect, in response to an operator clicking the configuration button a specified number of times, the NTS system control card will instruct the NTS printer to print out gaming machine auditing data. By monitoring all ccTalk, SAS or Xseries traffic, the NTS system control card 1000 can build up a complete cash-in cash-out record from the gaming machine.

In another aspect, clicking the configuration button a specified number of times, such as twice, causes the NTS system control card 1000 to instruct the NTS printer 1012 to print out all audit data and payout information in computer readable indicia, such as a 2D barcode, onto voucher 1016, which can be scanned (1020) into the redemption device 1018 to maintain record of all transactions.

In another aspect, all auditing data is captured and automatically downloaded online by the redemption device 1018 to a central source for a full cash audit.

In another aspect, an operator of the gaming machine uses an SD card written to by the redemption device and read by the NTS system control card 1000 to download setup offers and promotions or even news about the gaming establishment to print out at the same time by the NTS printer 1012 as cashout vouchers or tickets.

In another aspect, both the NTS system control card 1000 and NTS printer 1012 generate an encryption key internally using random number generator. Holding the configuration button on the NTS system control card for a specified period of time, such as 10 seconds, creates a new key which is encrypted and sent to the NTS printer 1012. A second key based on the time of the generation will also be sent for the checksum on every cashout voucher or ticket. The NTS printer 1012 then generates its own key for encrypting the computer-readable indicia, such as a 2D barcode, and prints out all 3 keys in the form of computer-readable indicia, such as a 2d barcode. This encryption key voucher or ticket is taken and scanned (1020) into the redemption device 1018 to register the new keys, and the key voucher or ticket will then be destroyed. When a new machine is introduced, the configuration button on the NTS system control card 1000 will be held by an operator to generate a new set of keys which will be scanned (1020) into the redemption device 1018.

In another aspect, to complete an audit and to check vouchers and tickets, an audit computer-readable indicia, such as a barcode, can be printed off by the NTS printer 1012 at the end of the day to consolidate the audit. Also by monitoring the coin and cash in over ccTalk, SAS or Xseries, the NTS system can provide an accurate audit of the gaming machines usage and reduce shrinkage. If a gaming machine operator is worried about a security breach, new keys can be re-generated on a regular basis.

In another aspect, and as described herein, the functionality of the NTS system control card 1000 may be incorporated into a gaming machine controller (not shown) as either a control module or as program control instructions executed by the gaming machine controller (not shown).

The foregoing description of features, aspects and functions of an NTS system are to be understood as illustrative. Those skilled in the art of gaming systems will recognize that the physical features, aspects and functions described herein are not mutually exclusive and may be deleted and/or combined with other features, aspects and functions as described herein or known in the art as may suit a particular implementation or purpose.

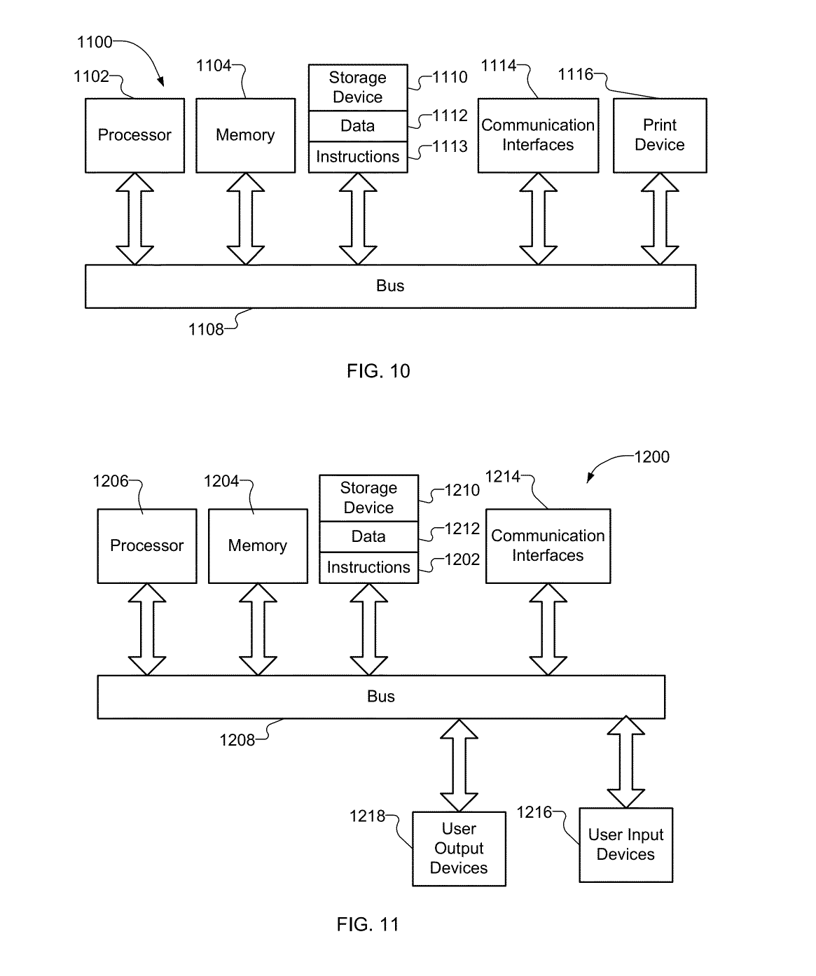

FIG. 10 is an architecture diagram of a data processing device of an NTS printer in accordance with the present disclosure. A data processing device 1100, such as a general purpose computing device or a controller, may be used to implement the features, functions and aspects of an NTS printer as described herein. In the data processing device 1100, a processor 1102 is operatively connected to a memory 1104 by a bus 1108. The processor 1102 is also operatively connected to non-transitory processor-readable storage media, such as a storage device 1110, that stores processor-executable instructions 1113 and processor-readable data 1112. The processor 1102 is also operatively connected to one or more communication interfaces 1114 that may be used to operatively connect the data processing device 1100 to other devices as well as networks as described herein.

In operation, the processor 1102 loads the processor-executable instructions 1113 and processor-readable data 1112 into the memory 1104 and executes the instructions 1113 and operates on the data 1112 to implement the various aspects and features of an NTS printer as described herein.

FIG. 11 is an architecture diagram of a data processing device of an NTS system control card in accordance with the present disclosure. A data processing device 1200, such as a general purpose computing device or a controller, may be used to implement the features, functions and aspects of an NTS system control card as described herein. In the data processing device 1200, a processor 1206 is operatively connected to a memory 1204 by a bus 1208. The processor 1206 is also operatively connected to non-transitory processor-readable storage media, such as a storage device 1210, that stores processor-executable instructions 1202 and processor-readable data 1212. The processor 1206 is also operatively connected to one or more communication interfaces 1214 that may be used to operatively connect the data processing device 1200 to other devices as well as networks as described herein. The processor 1206 is also operatively connected via the bus 1208 to one or more user input devices 1216 and one or more user output devices 1218.

In operation, the processor 1206 loads the processor-executable instructions 1202 and processor-readable data 1212 into the memory 1204 and executes the instructions 1202 and operates on the data 1212 to implement the various aspects and features of a NTS system control card as described herein. The processor 1206 uses the one or more user input devices 1216 and one or more user output devices 1218 in accordance with the processor-executable instructions 1202 and processor-readable data 1212 in order to create and operate user interfaces for a gaming machine operator as described herein.

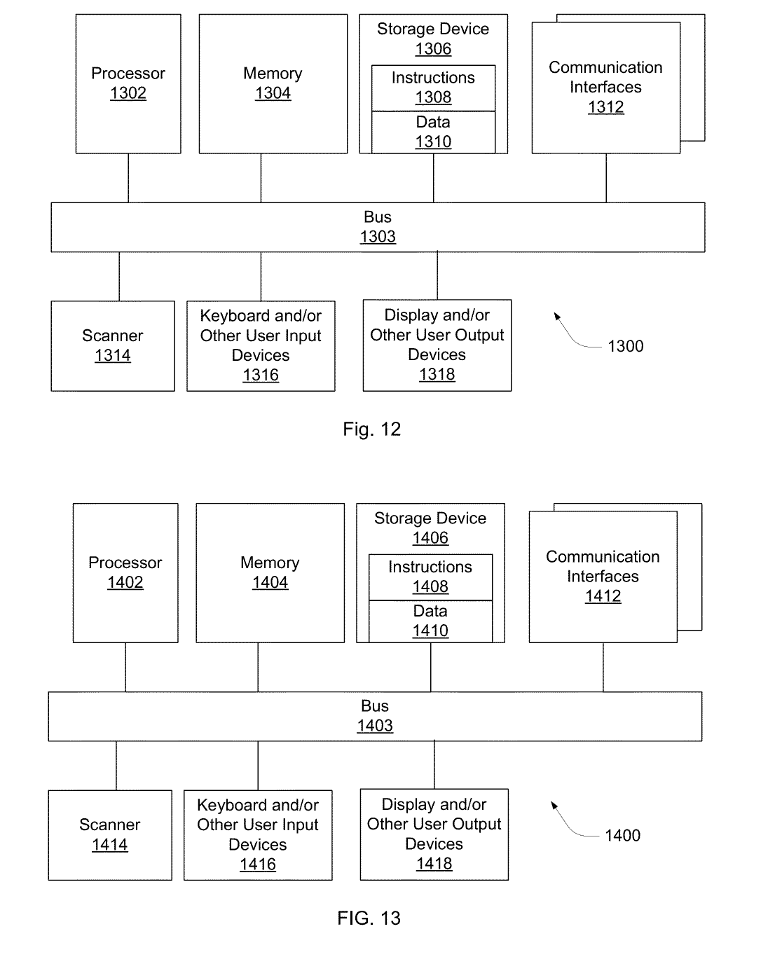

FIG. 12 is an architecture diagram of a redemption device in accordance with the present disclosure. A data processing device, such as a personal computer, a general purpose computing device or a controller, may be used to implement the features, functions and aspects of a redemption device 1300 as described herein. In the redemption device 1300, a processor 1302 is operatively connected to a memory 1304 by a bus 1303. The processor 1302 is also operatively connected to non-transitory processor-readable storage media, such as a storage device 1306, that stores processor-executable instructions 1308 and processor-readable data 1308. The processor 1302 is also operatively connected to one or more communication interfaces 1312 that may be used to operatively connect the redemption device 1300 to other processing devices as well as networks as described herein. The processor 1302 is also operatively connected via the bus 1303 to one or more user input devices 1316 and one or more user output devices 1318. The processor 1302 may also be operatively connected to a scanner 1314 for scanning a cashout voucher or ticket for computer-readable indicia as described herein.

In operation, the processor 1302 loads the processor-executable instructions 1308 and processor-readable data 1310 into the memory 1304 and executes the instructions 1308 and operates on the data 1310 to implement the various aspects and features of a redemption device as described herein. The processor 1302 uses the one or more user input devices 1316 and one or more user output devices 1318 in accordance with the processor-executable instructions 1308 and processor-readable data 1310 in order to create and operate user interfaces for a gaming machine operator as described herein.

FIG. 13 is an architecture diagram of a redemption terminal in accordance with the present disclosure. A data processing device, such as a personal computer, a general purpose computing device or a controller, may be used to implement the features, functions and aspects of a redemption terminal 1300 as described herein. In the redemption terminal 1400, a processor 1402 is operatively connected to a memory 1404 by a bus 1403. The processor 1402 is also operatively connected to non-transitory processor-readable storage media, such as a storage device 1406, that stores processor-executable instructions 1408 and processor-readable data 1408. The processor 1402 is also operatively connected to one or more communication interfaces 1412 that may be used to operatively connect the redemption terminal 1400 to other processing devices as well as networks as described herein. The processor 1402 is also operatively connected via the bus 1403 to one or more user input devices 1416 and one or more user output devices 1418. The processor 1402 is also operatively connected to a scanner 1414 for scanning a cashout voucher or ticket for computer-readable indicia as described herein.

In operation, the processor 1402 loads the processor-executable instructions 1408 and processor-readable data 1410 into the memory 1404 and executes the instructions 1408 and operates on the data 1410 to implement the various aspects and features of a redemption terminal as described herein. The processor 1402 uses the one or more user input devices 1416 and one or more user output devices 1418 in accordance with the processor-executable instructions 1408 and processor-readable data 1410 in order to create and operate user interfaces for a gaming machine operator as described herein.

Although certain specific features, functions and aspects of an NTS system have been described herein, many additional modifications and variations would be apparent to those skilled in the art. For example, the features and aspects described herein may be implemented independently, cooperatively or alternatively without deviating from the spirit of the foregoing description. It is therefore to be understood that an NTS system as described herein may be practiced otherwise than as specifically described. Thus, the foregoing description of the NTS system should be considered in all respects as illustrative and not restrictive of the scope any claims supported by this application and the claims' equivalents.

### APPENDIX A

For the purposes of this disclosure, the following definitions apply:

“Gaming Establishment”—A gaming entity such as a casino or pub.

“Gaming Machine”—A gambling game, slot machine, gaming machine, or game table in a gaming establishment.

“Host System”—A computer, back-end system, gaming system, network, or other system that sends and/or receives information to and/or from a gaming machine, a printer or other component associated with the gaming machine. Examples of a host system include a wagering issuance and redemption system, cash-out voucher system, a player tracking system, and a promotional coupon system, among others.

“Point of Redemption”—Any kiosk, point-of-sale, cashier's cage, or other means whereby a player can redeem a game voucher, promotional coupon, progressive coupon, or temporary player club registration tickets.

“Voucher”, “Cashout Voucher” or “Ticket”—Media, such as paper or rewritable card, containing sufficient information to identify at a minimum, an amount of money and a validation number used to authenticate a transaction.

“NTS”—acronym for Networkless Ticketing Solution

“Promotional Coupon”—Media, such as paper or rewritable card, containing sufficient information to identify at a minimum, a promotional event or a promotional reward to a player and validation information.

“Rewritable Card”—Media such as a smart card, magnetic media, thermal media, thermal reversible media, RF fiber media, RFID tag media, or write once media, which may be used for game vouchers and promotional coupons.

“Printer Controller”—Device internal or external to a printer, which controls print jobs and receives and/or transmits data, among other functions.

What is claimed is:

1. A method of providing networkless ticketing, comprising:
generating, by a control card, an encryption key;
transmitting, by the control card to a printer, the encryption key;
printing, by the printer, as first computer-readable indicia, the encryption key onto a ticket;
scanning, by a redemption device, the first computer-readable indicia to determine the encryption key;
receiving, by the control card from a gaming machine controller, a cashout amount for a player playing a gaming machine controlled by the gaming machine controller;
encrypting the cashout amount by the control card using the previously generated encryption key;
transmitting, by the control card, the encrypted cashout amount to the printer;
printing, by the printer, the encrypted cashout amount in second computer-readable indicia onto a cashout ticket;
scanning, by the redemption device, the second computer-readable indicia from the cashout ticket;
using, by the redemption device, the previously determined encryption key to decrypt the encrypted cashout amount read from the second computer readable indicia on the cashout ticket; and
displaying, by the redemption device, the cashout amount.

2. The method of claim 1, further comprising:
generating, by the printer, a second encryption key;
printing, by the printer, as a portion of the first computer-readable indicia, the second encryption key onto the ticket;
scanning, by the redemption device, the first computer-readable indicia to determine the second encryption key;
encrypting, by the printer, the encrypted cashout amount using the second encryption key before printing the encrypted second computer-readable indicia onto the cashout ticket; and
using, by the redemption device, the previously determined encryption key and second encryption key to decrypt the encrypted cashout amount read from the second computer readable indicia on the cashout ticket.

3. The method of claim 1, wherein the encryption is performed using a private key and the decryption is performed using a public key.

4. The method of claim 1, wherein the control card uses a private key to encrypt the cashout amount, the method further comprising:
generating, by the control card, the private encryption key and a public decryption key;
transmitting, by the control card to the printer, the public decryption key;
printing, by the printer, as the first computer-readable indicia, the public decryption key onto a ticket;
scanning, by the redemption device, the first computer-readable indicia to determine the public decryption key; and
using, by the redemption device, the public decryption key to decrypt the encrypted cashout amount read from the second computer-readable indicia of the cashout ticket.

5. The method of claim 1, wherein the control card is incorporated into the gaming machine controller as a control module.

6. The method of claim 1, wherein the control card is incorporated into the gaming machine controller as program control instructions.

7. The method of claim 1, wherein the second computer-readable indicia includes historical ticket data about one or more previous tickets printed by the printer.

8. The method of claim 7, wherein the redemption device further uses the historical ticket data to validate the ticket.

9. The method of claim 1, wherein the second computer-readable indicia further includes non-encrypted ticket data.

10. The method of claim 1, further comprising generating by the control card a new encryption key in response to a configuration instruction.

11. A networkless ticketing system, comprising:
a network control card constructed to:
generate an encryption key;
transmit, to a printer, the encryption key;
receive, from a gaming machine controller, a cashout amount for a player playing a gaming machine controlled by the gaming machine controller;
encrypt the cashout amount using the previously generated encryption key; and
transmit, to the printer, the encrypted cashout amount;
the printer constructed to:
print, as first computer-readable indicia, the encryption key onto a ticket; and
print, as second computer-readable indicia, the encrypted cashout amount onto a cashout ticket; and
a redemption device constructed to:
scan the first computer-readable indicia from the ticket to determine the encryption key;
scan the second computer-readable indicia from the cashout ticket;
use the previously determined encryption key to decrypt the encrypted cashout amount read from the second computer readable indicia of the cashout ticket; and
display the cashout amount.

12. The system of claim 11,
wherein the printer is further constructed to:
generate a second encryption key;
print, as a portion of the first computer-readable indicia, the second encryption key onto the ticket; and
encrypt the encrypted cashout amount using the second encryption key before printing the encrypted second computer-readable indicia onto the cashout ticket, and
wherein the determination device is further constructed to:
scan the first computer-readable indicia to determine the second encryption key; and
use the previously determined encryption key and second encryption key to decrypt the encrypted cashout amount read from the second computer readable indicia on the cashout ticket.

13. The system of claim 11, wherein the encryption is performed using a private key and the decryption is performed using a public key.

14. The system of claim 11,
wherein the control card is further constructed to:
use a private key to encrypt the cashout amount;
generate the private encryption key and a public decryption key; and
transmit, to the printer, the public decryption key,
wherein the printer is further constructed to print as the first computer-readable indicia, the public decryption key onto the ticket, and
wherein the redemption device is further constructed to:
scan the first computer-readable indicia to determine the public decryption key; and
use the public decryption key to decrypt the encrypted cashout amount read from second computer readable indicia of the cashout ticket.

15. The system of claim 11, wherein the control card is incorporated into the gaming machine controller as a control module.

16. The system of claim 11, wherein the control card is incorporated into the gaming machine controller as program control instructions.

17. The system of claim 11, wherein the control card is further constructed to spoof a coin hopper or cash dispenser to the gaming machine controller.

18. The system of claim 17, wherein the control card is further constructed to make a determination of whether or not to use the coin hopper or cash dispenser for a payout based on a cashout amount.

19. The system of claim 17, wherein the control card is further constructed to:
determine if the coin hopper or cash dispenser is empty; and
use the printer for all payouts if the coin hopper or cash dispenser is empty.

20. The system of claim 11, wherein the control card is further constructed to generate a new encryption key in response to a configuration instructions.
